(19) United States
(12) Patent Application Publication
(10) Pub. No.: US 2008/0285988 A1
(43) Pub. Date: Nov. 20, 2008

(54) Image forming apparatus and recording-medium feeding method

(75) Inventors: Wataru Uchida, Mishima-shi (JP); Kazuhiro Hosohara, Susono-shi (JP); Marehiko Hirajima, Mishima-shi (JP); Yuya Kojima, Suntou-gun (JP); Yoshihiro Ito, Mishima-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/953,683

(22) Filed: Dec. 10, 2007

(30) Foreign Application Priority Data
Dec. 13, 2006 (JP) 2006-336010

(51) Int. Cl. G03G 15/00

(52) U.S. Cl. 399/43

(57) ABSTRACT

An image forming apparatus includes a storage unit configured to store a recording medium, an image forming unit configured to form an image on the recording medium, a paper feed unit configured to supply the recording medium from the storage unit, a conveying unit configured to convey the recording medium supplied by the paper feed unit to the image forming unit, and a control unit configured to control the paper feed unit and the conveying unit in conveying the recording medium. In accordance with a conveyance state in which the recording medium supplied from the storage unit by the paper feed unit is conveyed to the conveying unit, the control unit controls the conveying speed of the next recording medium supplied by the paper feed unit.

### BACKGROUND OF THE INVENTION

1. Field of the Invention

The present invention relates to an image forming apparatus that forms an image on a recording medium, and to a paper feeding device in the image forming apparatus. More particularly, the present invention relates to an image forming apparatus having a function of a copying machine or a printer, a multifunction machine having a copying function and a document reading function, a color printer that forms a color image on a recording medium, and a recording-medium feeding method for the color printer.

2. Description of the Related Art

In recent years, a color printer serving as an image forming apparatus has been frequently shared by a plurality of host computers while being connected to the host computers via a network. A typical color-image forming apparatus is an electrophotographic color laser beam printer that has a low operating cost and that is not prone to failure.

There is a demand for a color laser beam printer capable of forming images on various types of recording media. For example, it is important, in improving usability, to print on a wide variety of types of recording media including plain paper, thin paper, thick paper, and glossy paper, to perform precise printing on a recording medium of a specified size, and to print at high speed.

In such a color laser beam printer, however, the quality of an output image is sometimes deteriorated or an undesirable image is output because of an environmental change at an installation site of the printer, and changes and deterioration of components of the printer due to long-term use.

For example, Japanese Patent Laid-Open No. 11-194561 (corresponding to U.S. Pat. No. 6,014,542) discloses an image forming apparatus that achieves precise printing on recording media and precise printing on recording media of a specified size.

More specifically, the disclosed image forming apparatus includes a means for detecting the leading edge of an image formed on an intermediate transfer belt, a means for detecting a leading edge of a recording medium placed between a registration roller and a transfer roller, and a means for controlling the speed of the registration roller. The recording medium is conveyed to the transfer roller, while the registration roller controls the conveying speed of the recording medium in synchronization with the leading edge of the image.

Japanese Patent Laid-Open No. 2001-213537 (corresponding to U.S. Pat. No. 6,502,818) discloses a technique of achieving high-speed image formation.

In this technique, a recording-medium detector is placed between a paper feed roller and a registration roller, and the speed of the paper feed roller is controlled in accordance with the detection result of the recording-medium detector. This can reduce the variations in time taken for the recording medium to reach the registration roller, and can decrease the paper feed interval. Therefore, printing can be performed on more recording media within a fixed period of time.

In the technique disclosed in Japanese Patent Laid-Open No. 11-194561, for example, precise printing can be performed on a recording medium of a specified size. However, this technique is not adequate for high-speed image formation.

In contrast, Japanese Patent Laid-Open No. 2001-213537 discloses the above-mentioned technique of increasing the image formation speed. However, this technique does not consider variations in the conveying speed of the recording medium and variations in the conveying path between the paper feed roller and the registration roller due to the type of recording medium, the environment of the apparatus, the use state of the apparatus, and the manufacturing tolerance of the components of the apparatus.

In particular, in a case in which the conveying speed of the recording medium varies and the conveying path between the paper feed roller and the registration roller varies, after the recording medium is detected by the recording-medium detector, the time taken for the recording medium to reach the registration roller is not fixed and is unstable. The variation in the time of arrival at the registration roller due to the variation in conveying speed of the recording medium is influenced particularly by the type of recording medium and the environment of the apparatus. When the type of recording medium is changed, the conveyance state also changes even if a command is issued to convey the recording medium at the same speed. Further, even when the same type of recording medium is used, the conveyance state changes in accordance with the environment.

In order to remove the variations in the time taken for the recording medium to reach the registration roller, it is conceivable to increase the feeding interval between the recording media. It is also conceivable to increase the distance between the registration roller and the transfer roller. However, when the feeding interval is increased, the number of recording media conveyed per unit time decreases, and this reduces productivity. Further, when the distance between the registration roller and the transfer roller is increased, the conveying distance is increased, and the size of the body of the apparatus is increased.

Although it is possible to limit the type of paper to be used, for example, so as not to use thick paper and glossy paper, usability is impaired in this case.

### SUMMARY OF THE INVENTION

The present invention provides an image forming apparatus that can suppress a decrease in productivity and that can precisely form images on various types of recording media, and a recording-medium feeding method for the image forming apparatus.

An image forming apparatus according to an aspect of the present invention includes a storage unit configured to store a recording medium; an image forming unit configured to form an image on the recording medium; a paper feed unit configured to supply the recording medium from the storage unit; a conveying unit configured to convey the recording medium supplied by the paper feed unit to the image forming unit; and a control unit configured to control the paper feed unit and the conveying unit for conveying the recording medium.

In accordance with a conveyance state in which the recording medium supplied from the storage unit by the paper feed unit is conveyed to the conveying unit, the control unit sets a conveying speed of the next recording medium supplied by the paper feed unit.

A recording-medium feeding method according to another aspect of the present invention is provided for an image forming apparatus including a storage unit configured to store a recording medium, an image forming unit configured to form an image on the recording medium, a paper feed unit configured to supply the recording medium from the storage unit. The recording-medium feeding method includes the steps of detecting a conveyance state in which the recording medium stored in the storage unit is supplied, and controlling a conveying speed of the next recording medium supplied by the paper feed unit in accordance with the conveyance state.

Further features of the present invention will become apparent from the following detailed description of exemplary embodiments with reference to the attached drawings.

### BRIEF DESCRIPTION OF THE DRAWINGS

FIG. 1 includes a partial cross-sectional view and a control block diagram of a paper feeding device according to a first exemplary embodiment of the present invention.

FIG. 2 is a partial cross-sectional view showing the operation of the paper feeding device.

FIG. 3 is a plot graph showing variations in the conveying time of a recording medium in the first exemplary embodiment.

FIG. 4 is a plot graph showing variations in the conveying time of the recording medium in the first exemplary embodiment.

FIG. 5 is a partial cross-sectional view showing a configuration of a paper feeding device according to a second embodiment of the present invention.

FIG. 6 is a partial cross-sectional view showing a configuration of a paper feeding device according to a third embodiment of the present invention.

FIG. 7 is a cross-sectional side view conceptually showing the entire color image forming apparatus according to the first exemplary embodiment.

FIG. 8 is a flowchart showing an operating sequence in the first exemplary embodiment.

FIG. 9 is a flowchart showing an operating sequence in the first exemplary embodiment.

FIG. 10 is a partial cross-sectional view showing a configuration of the feeding device according to the first exemplary embodiment.

### DESCRIPTION OF THE EMBODIMENTS

Embodiments of the present invention will be described in detail below with reference to the drawings.

### First Exemplary Embodiment

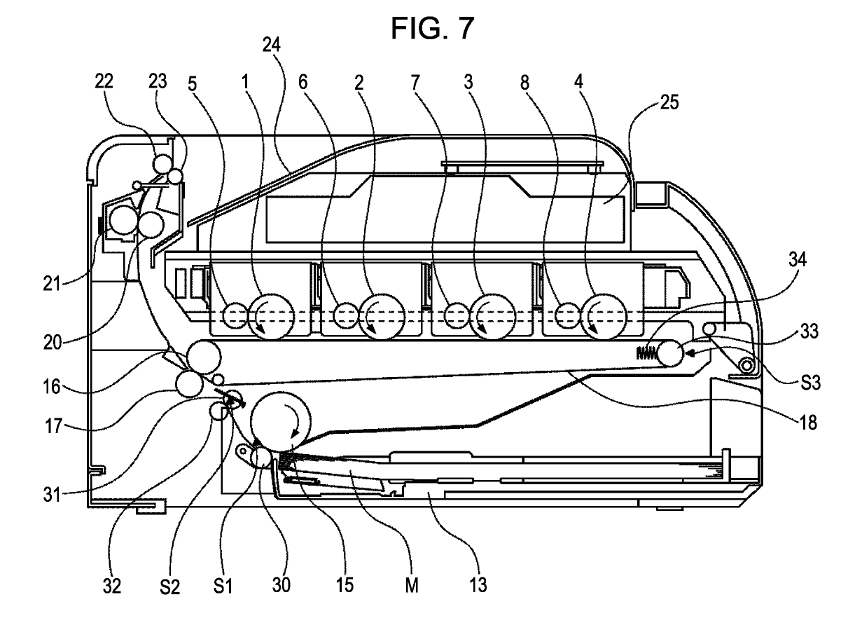

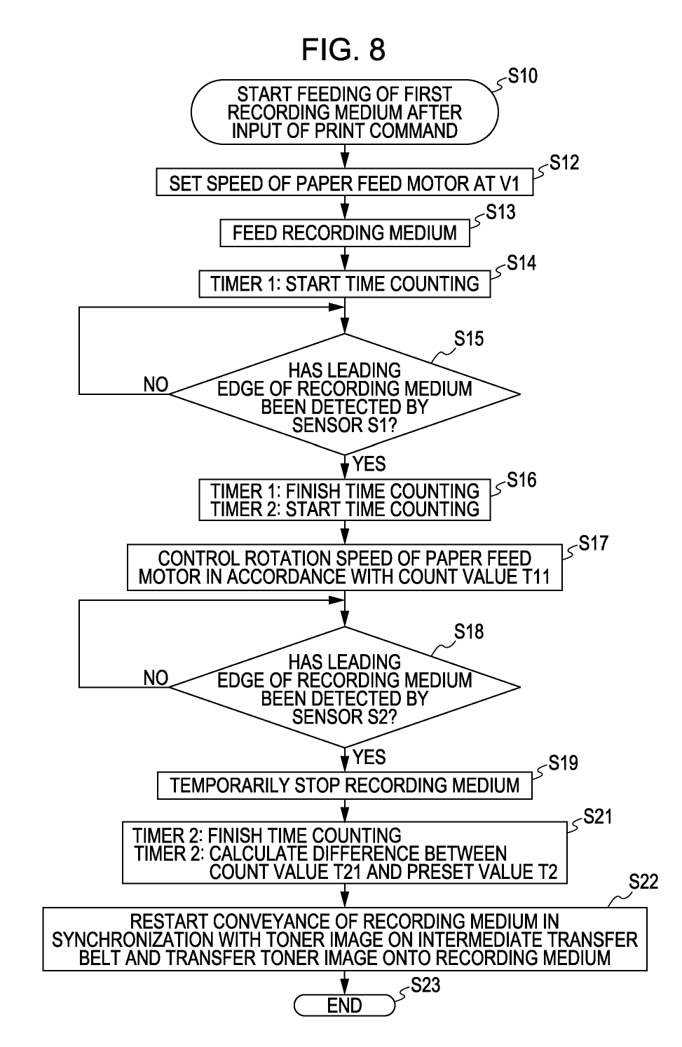

First, the overall configuration and operation of an image forming apparatus according to a first exemplary embodiment of the present invention will be described with reference to FIG. 7.

FIG. 7 is a schematic cross-sectional view of a full-color image forming apparatus according to the first exemplary embodiment. The full-color image forming apparatus is a full-color printer that performs image formation with toners of four colors and that includes four image-bearing members corresponding to the four colors.

A body of the printer includes photosensitive drums 1, 2, 3, and 4 serving as image bearing members, a laser scanner unit 25 that exposes the photosensitive drums, and developing rollers 5, 6, 7, and 8 that develop latent images formed on the photosensitive drums. The body of the printer also includes an intermediate transfer belt 18, a fixing film 20, a pressure roller 21, a paper feed tray 13, and a paper feed roller 15.

Recording media M stacked in the paper feed tray 13 are separated and supplied by a separation roller 30 and the paper feed roller 15 that rotates in the direction of the arrow in FIG. 7. A separated recording medium M is conveyed while being nipped between opposing registration rollers 31 and 32, and is sent to a nip between a driving roller 16 that drives the intermediate transfer belt 18, and a transfer roller 17.

The photosensitive drums 1, 2, 3, and 4 rotate in the direction of the arrows in FIG. 7 (counterclockwise). Electrostatic latent images are sequentially formed on the outer peripheral surfaces of the photosensitive drums 1, 2, 3, and 4 by laser light emitted from the laser scanner unit 25. The formed electrostatic latent images are developed into toner images by the developing rollers 5, 6, 7, and 8 corresponding to the photosensitive drums.

The toner images formed on the photosensitive drums 1, 2, 3, and 4 are then transferred onto the intermediate transfer belt 18. In order to form a color image, yellow, magenta, cyan, and black toner images are respectively formed on the photosensitive drums 1, 2, 3, and 4, and are transferred onto the intermediate transfer belt 18.

Subsequently, the toner images transferred on the intermediate transfer belt 18 are transferred onto the recording medium M conveyed to the nip between the driving roller 16 and the transfer roller 17.

The recording medium M on which the toner images are transferred is conveyed to a nip between the fixing film 20 and the pressure roller 21, and the toner images are fixed on the recording medium M by heat and pressure at the nip.

The recording medium M on which the toner images are fixed is output into an output tray 24 by output rollers 22 and 23.

The full-color printer performs image formation through the above-described procedure.

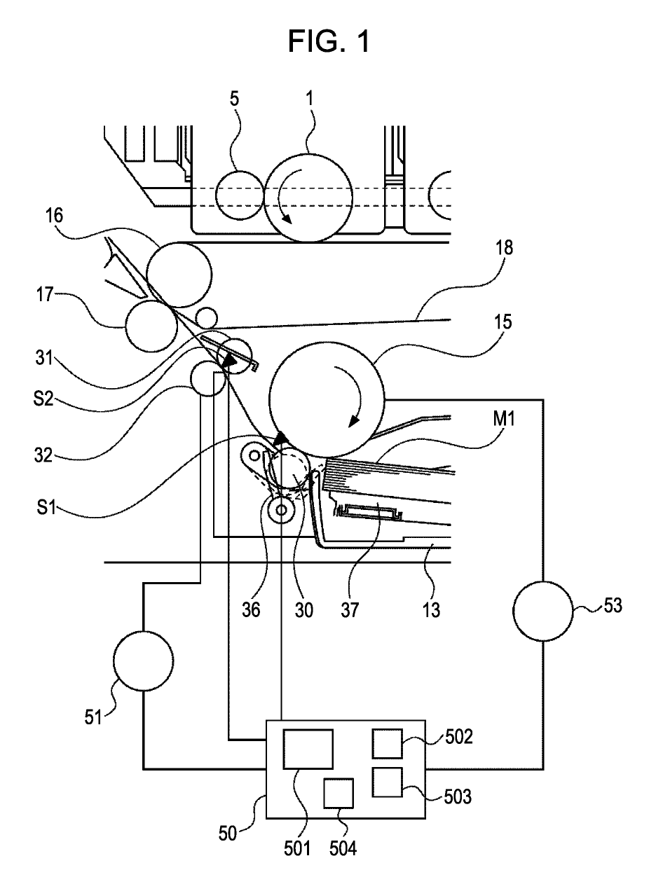

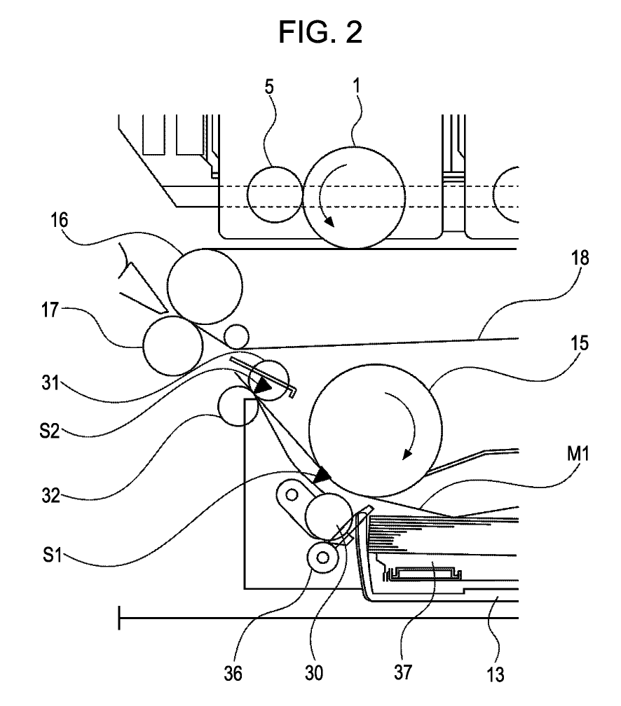

The characteristic structure and operation of the first exemplary embodiment will now be described in detail with reference to FIGS. 1 and 2.

FIG. 1 is a detailed partial cross-sectional view of the paper feed section shown in FIG. 7.

First, a description will be given of operations of the image forming apparatus for feeding the first recording medium and forming an image on the recording medium in response to a print command.

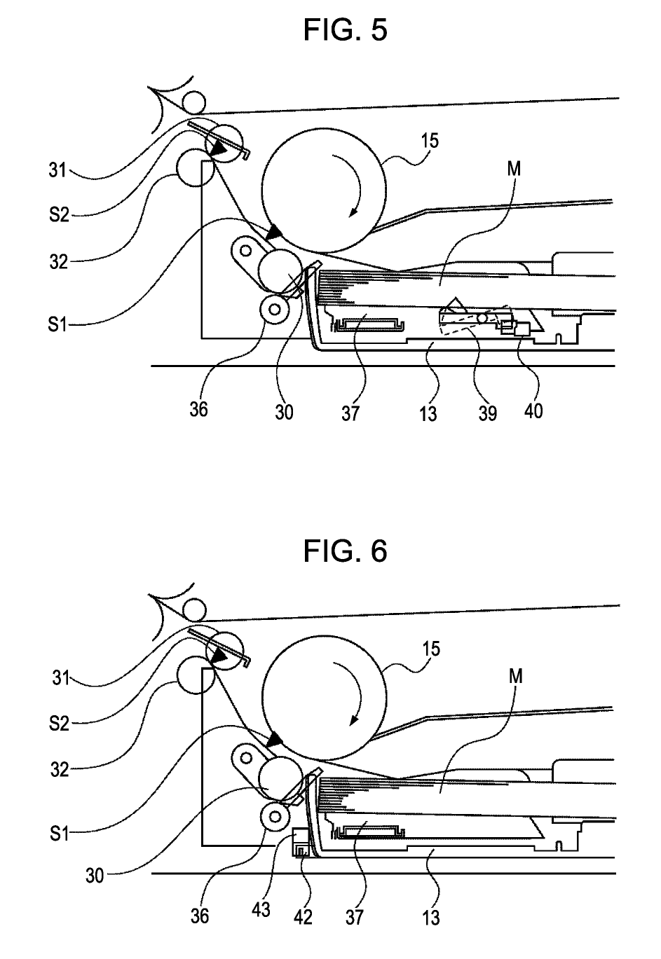

When the image forming apparatus receives a print command, a paper feed clutch 39 (FIG. 5) operates, a paper feed motor 53 is driven, and the driving is transmitted to rotate the paper feed roller 15. Then, a cam mechanism (not shown) operates to press the separation roller 30 into contact with the paper feed roller 15, and a return lever 36 comes out of a conveying path. Finally, the uppermost medium M1 of the recording media M stacked on an intermediate plate 37, which is pivotally mounted in the paper feed tray 13 and is biased upward by a spring (not shown), is pressed into contact with the paper feed roller 15, and is separated and conveyed by the paper feed roller 15 and the separation roller 30.

In order to control the rotation speed of the paper feed roller 15, a time T11 between the time when the driving force of the paper feed motor 53 is transmitted to the paper feed roller 15 and the time when the recording medium M1 reaches a paper sensor S1 disposed between the paper feed roller 15 and the registration roller 31 is detected, and the rotation speed of the paper feed motor 53 is controlled on the basis of the detected time T11.

The rotation speed of the paper feed roller 15 is controlled so that a time T21 taken for the recording medium M1 to be conveyed from the paper sensor S1 to a registration sensor S2 disposed between the registration roller 31 and the transfer roller 17 becomes equal to a preset time T2.

The rotation speed of the paper feed roller 15 is controlled so as to correct variation in the feeding timing of the recording medium M. Variation in the paper feed timing is corrected on the basis of the time between the time when paper feeding starts and the time when the recording medium M reaches the paper sensor S1, thus improving the conveyance accuracy.

In the first exemplary embodiment, the registration sensor S2 is disposed at the nip between the registration rollers 31 and 32. The position of the registration sensor S2 is not limited to the nip, and can be changed to other positions best suited to detect the recording medium.

After the time T21 taken for the recording medium M1 to be conveyed from the paper sensor S1 to the registration sensor S2 is detected, the separation roller 30 is separated from the paper feed roller 15 by the cam mechanism. Then, a recording medium stopped at the nip between the paper feed roller 15 and the separation roller 30 is returned into the paper feed tray 13 by the return lever 36. Subsequently, the driving of the paper feed motor 53 is interrupted by the paper feed clutch 39, and the paper feed roller 15 is thereby stopped. After the recording medium M1 is conveyed by a predetermined distance by the registration roller 31, a registration-roller driving motor 51 stops, and the registration roller 31 also stops. Consequently, the recording medium M1 is stopped between the registration roller 31 and the transfer roller 17. This state is shown in FIG. 2.

The distance between an image forming position on the photosensitive drum 1 and the transfer position of the transfer roller 17 is longer than the distance between the paper feed roller 15 and the transfer position of the transfer roller 17. Therefore, the first recording medium after the input of the print command is supplied prior to formation of an image (a toner image) on the photosensitive drum 1. This can shorten the time taken to form an image on the first recording medium, and perform image formation without decreasing the number of recording media on which images are formed per unit time (hereinafter referred to as a throughput). Further, an image can be accurately formed (transferred) on the recording medium after the recording medium is temporarily stopped.

More specifically, the recording medium is temporarily stopped while being nipped between the registration rollers 31 and 32, and the conveyance of the recording medium is restarted in synchronization with the toner image on the intermediate transfer belt 18.

For that purpose, when the toner image formed on the intermediate transfer belt 18 comes close to the nip between the transfer roller 17 and the driving roller 16, the registration-roller driving motor 51 starts to rotate the registration roller 31.

The start timing of the registration-roller driving motor 51 is determined so that the leading edges of the toner image on the intermediate transfer belt 18 and the fed recording medium M1 coincide with each other at the nip between the transfer roller 17 and the belt driving roller 16.

A detailed description will now be given of operations of the image forming apparatus and the paper feeding device for making the second to last prints.

After the trailing edge of the recording medium M1 passes the paper feed sensor S1, the driving of the paper feed motor 53 is transmitted to the paper feed roller 15 by the paper feed clutch 39, and the paper feed roller 15 is rotated. A recording medium Mn (n is an integer of two or more) placed under the recording medium M1 is separated and conveyed, in a manner similar to that for the recording medium M1. A time T1n when the recording medium Mn reaches the paper sensor S1 is detected.

The rotation speed of the paper feed roller 15 is controlled so that the time taken for the recording medium Mn to be conveyed from the paper sensor S1 to the registration sensor S2 disposed between the registration roller 31 and the transfer roller 17 becomes equal to the preset time T2.

To this control, a difference between the time T21 taken for the recording medium M1 to be conveyed from the paper sensor S1 to the registration sensor S2, and the preset time T2 is fed back.

That is, when T21 is less than T2, the rotation speed of the paper feed motor 53 is set so that the rotation speed for the recording medium Mn is lower than the rotation speed for the recording medium M1. Conversely, when T21 is more than T2, the rotation speed of the paper feed motor 53 is set so that the rotation speed for the recording medium Mn is higher than the rotation speed for the recording medium M1.

When the registration sensor S2 detects the arrival of the recording medium Mn, the rotation speed of the registration roller 31 is controlled without stopping the registration-roller driving motor 51. The rotation speed of the registration roller 31 is controlled so that the leading ends of the toner image on the intermediate transfer belt 18 and the recording medium Mn coincide with each other at the nip between the transfer roller 17 and the belt driving roller 16.

In the first exemplary embodiment, the following means is adopted in order to calculate the feeding amount of the toner image without any influence of expansion and contraction of the intermediate transfer belt 18.

The intermediate transfer belt 18 is biased by a belt tensioning spring 34 so as to have a constant tension. A leading end of a seal stuck on the intermediate transfer belt 18 in the width direction is detected by an optical sensor S3 that moves together with a belt tension roller 33 movable in the horizontal direction in FIG. 7. The seal has a reflectance different from that of a portion provided outside an image forming region on a surface of the intermediate transfer belt 18 on which the toner image is transferred. The length of the intermediate transfer belt 18 can be calculated from the interval at which the leading end of the seal is detected.

Since the positions of the photosensitive drums 1, 2, 3, and 4, the transfer roller 17, and the belt driving roller 16 are known, the amount by which the toner image is conveyed (moving distance) can be calculated on the basis of the emitting timing of laser light from the laser scanner unit 25 onto the photosensitive drums 1, 2, 3, and 4.

The leading end of the toner image can be detected by an optical sensor that detects the difference in reflectance between the surface of the intermediate transfer belt 18 and the toner image. In this case, the optical sensor is placed at a constant distance from the nip between the transfer roller 17 and the belt driving roller 16. The constant distance is more than the distance from the nip between the transfer roller 17 and the belt driving roller 16 to the nip between the registration rollers 31 and 32.

The time taken for the first recording medium to move from the paper sensor S1 to the registration sensor S2 is detected, and is fed back to control the speed at which the second and subsequent recording media are conveyed by the paper feed roller 15. This increases the accuracy in controlling the conveyance of the recording medium M by the paper feed roller 15, and allows the recording medium M to reach the registration sensor S2 in the time closer to the preset time T2.

The conveying speed of the paper feed roller 15 varies for a plurality of reasons, for example, a change in roller diameter due to wear, a decrease in coefficient of friction, the environment of the apparatus, changes in the coefficient of friction with the paper feed roller 15 and in the conveying path in accordance with the type of recording medium, and an error in diameter of the paper feed roller 15 due to production errors of components. These reasons can be reduced by exerting the above-described feedback control. That is, the variation in the conveyance state of the recording medium can be corrected by the feedback control.

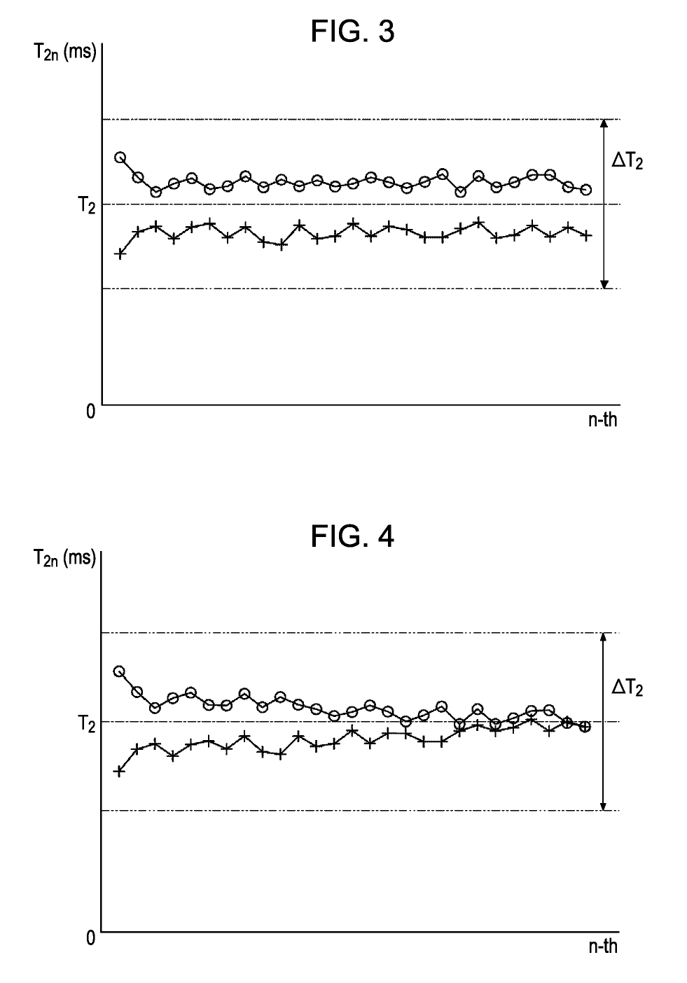

FIG. 3 shows examples of results of conveying-speed control exerted on two types of recording media according to the first exemplary embodiment.

In each type of recording medium, the conveying speeds of the second and subsequent recording media are changed, depending on whether the time T21 taken for the first recording medium to be conveyed from the paper sensor S1 to the registration sensor S2 is more than or less than the preset time T2. The time T2n taken for the n-th recording medium to be conveyed from the paper sensor S1 to the registration sensor S2 is controlled to be close to the preset time T2.

In the first exemplary embodiment, the rotation speed of the registration roller 31 can be controlled so that the time T2n is within a range ΔT2. This range ΔT2 refers to a range in which the rotation speed of the registration roller 31 can be adjusted so as to synchronize the recording medium with the toner image on the intermediate transfer belt 18. That is, when the difference between T2n and T2 is outside the range ΔT2, synchronization between the toner image and the recording medium cannot be achieved even by adjusting the rotation speed of the registration roller 31.

In the above-described procedure, the first recording medium supplied after the input of the print command is stopped temporarily. However, if the conveyance accuracy of the paper feed roller 15 and the separation roller 30 is within the predetermined range (within ΔT2), the sequence for temporarily stopping the first recording medium is unnecessary. In this case, control can be exerted without temporarily stopping the first recording medium, and the operating sequence for the second and subsequent recording media can be performed in the same manner. This can simplify the operating sequence of the image forming apparatus.

In the first exemplary embodiment, however, the first recording medium is temporarily stopped for precise image formation on the first recording medium. Particularly when the conveying path from the paper feed position to the transfer position is short, if image formation is performed without stopping the conveyance of the recording medium, it is difficult to register the recording medium with the image. Therefore, it is essential to feed the first recording medium earlier, temporarily stop the recording medium, and then convey the recording medium again.

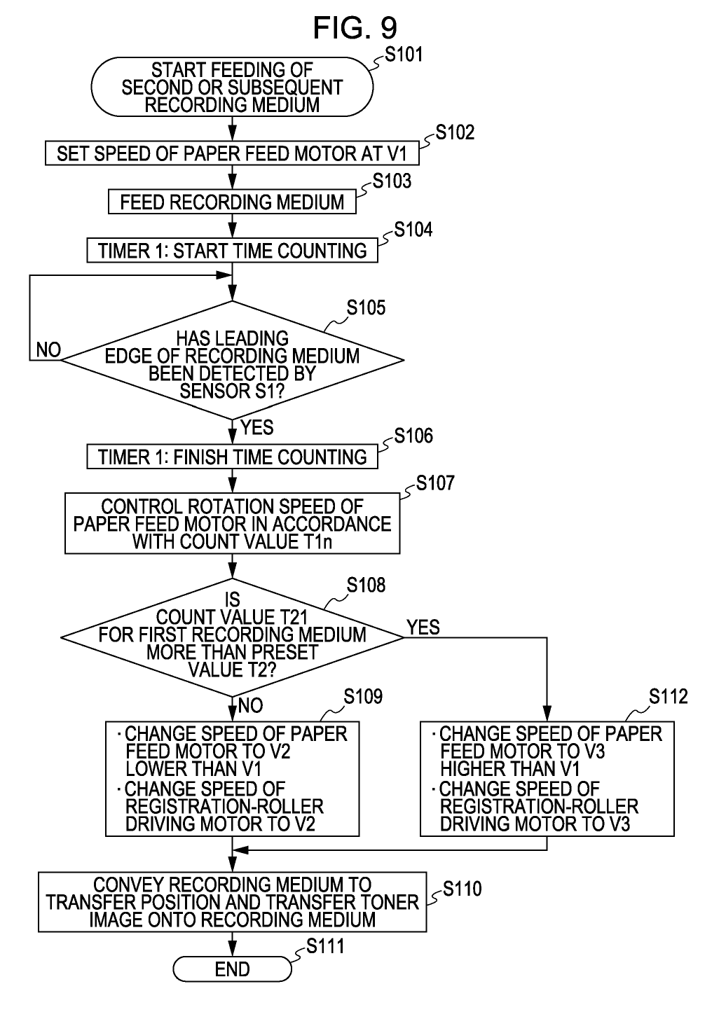

FIGS. 8 and 9 are flowcharts showing operating sequences in the first exemplary embodiment.

These operating sequences are carried out by controlling the operations of the paper feed clutch 39, the paper feed motor 53, and the registration-roller driving motor 51 by a controller 50 shown in FIG. 1. As shown in FIG. 1, the controller 50 monitors signals output from the sensors S1 and S2. The controller 50 includes a ROM 502 that stores programs for the operating sequences shown in FIGS. 8 and 9, a RAM 503 that temporarily stores and holds data, and a timer 504 that counts the time. The programs in the ROM 502 are read out by a CPU 501, and the following sequences are controlled with reference to the data in the RAM 503.

First, with reference to FIG. 8, a description will be given of an operating sequence in which the first recording medium after the input of a paper feed command is conveyed.

In response to a paper feed command, an operating sequence for the first recording medium starts (Step S10).

Then, the feeding speed of the recording medium is set at V1 (Step S12).

Subsequently, the recording medium is supplied by driving the paper feed clutch 39 and operating the paper feed motor 53 (Step S13).

Time counting with a timer 1 starts at the time when the paper feed motor 53 starts to operate (Step S14).

It is determined whether the leading edge of the recording medium has been detected by the paper sensor S1 (Step S15).

When the leading edge of the recording medium has been detected, the time counting with the timer 1 is finished, and time counting with a timer 2 is started (Step S16). In contrast, when the leading edge has not been detected, the time counting with the timer 1 is continued until the leading edge is detected. The time counting of the timers 1 and 2 is carried out by the timer 504 in the controller 50.

On the basis of a count value T11 of the timer 1, the rotation speed of the paper feed motor 53 is controlled. The rotation speed of the paper feed motor 53 is switched while comparing the count value T11 with the preset time T1. When T11 is more than T1, the rotation speed of the paper feed motor 53 is set to be higher than V1. In contrast, when T11 is less than T1, the rotation speed of the paper feed motor 53 is set to be lower than V1.

Then, it is determined whether the sensor S2 has detected the leading edge of the recording medium. When the leading edge has been detected, conveyance of the recording medium is stopped temporarily (Step S19). When the leading end has not been detected, the controller 50 monitors the output from the sensor S2 until the leading edge is detected.

Conveyance of the recording medium is temporarily stopped, and counting with the timer 2 is finished. Data on the difference between the count value T21 of the timer 2 and the preset value T2 is calculated, and is stored and held in the RAM 503 of the controller 50 (Step S21).

Subsequently, conveyance of the recording medium is restarted in synchronization with movement of the toner image formed on the intermediate transfer belt 18, and the toner image is transferred onto the recording medium (Step S22).

Then, the above-described sequence for feeding the first recording medium is completed (Step S23).

Referring to FIG. 9, a description will be given of an operating sequence in which the second and subsequent recording media after the input of the paper feed command are conveyed.

In response to a paper feed command, the operating sequence starts (Step S101).

The feeding speed of the recording medium is set at V1 (Step S102).

Then, a recording medium is supplied by driving the paper feed clutch 39 and operating the paper feed motor 53 (Step S103).

Time counting with the timer 1 is started at the time when the paper feed motor 53 starts (Step S104). The time counting with the timer 1 is carried out by the timer 504 provided in the controller 50. The operation of the timer 504 is reset each time a recording medium is supplied.

It is determined whether the paper sensor S1 has detected the leading edge of the recording medium (Step S105).

When the leading edge of the recording medium has been detected by the paper sensor S1, time counting with the timer 1 is finished, and time counting with a timer 2 is started (Step S106). Time counting is performed with the timer 504 in the controller 50. In contrast, when the leading edge has not been detected, the controller 50 monitors the output from the sensor S1 until the leading edge is detected.

On the basis of a count value T1n (n is an integer of 2 or more) of the timer 1, the rotation speed of the paper feed motor 53 is controlled (Step S107). This control is exerted similarly to Step S17 in FIG. 8.

Then, it is determined whether the leading edge of the recording medium has been detected by the registration sensor S2 (Step S108). When the leading edge has not been detected, the controller 50 monitors the output from the sensor S2 until the leading edge is detected.

After the leading edge of the recording medium is detected by the registration sensor S2, the count value T21 of the timer 2 for the first recording medium is compared with the preset value T2 (Step S109).

When T21 is more than T2, the driving speed of the paper feed motor 53 is set at a speed V3 higher than V1, the speed of the registration-roller driving motor 51 is also set at V3, and the recording medium is then conveyed toward the transfer position. When T21 is less than T2, the driving speed of the paper feed motor 53 is set at V2 lower than V1, the speed of the registration-roller driving motor 51 is also set at V2, and the recording medium is then conveyed toward the transfer position.

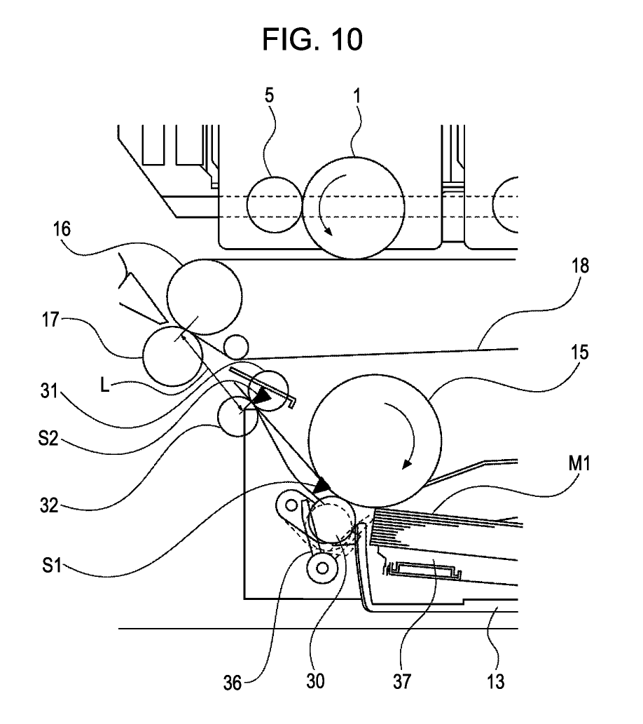

The speed V2 or V3 to which the speed V1 is switched is determined by the difference between the count value and the preset value T2. For example, when the count value is T21, a difference α is obtained by subtracting T2 from T21. When L represents the distance between the registration sensor S2 and the transfer position (see FIG. 10), V2 equals L/(T−α) and V3 equals L/(T+α).

Herein, T presents the period between the time when the leading edge of the recording medium is detected by the registration sensor S2 and the time when the leading edge reaches the transfer position under an ideal conveying condition where the recording medium is conveyed at the speed V1 so as to move from the sensor S1 to the sensor S2 in the preset time T2.

By the conveying-speed control adopted in the first exemplary embodiment, the recording medium can be precisely conveyed even when the distance between the registration roller 31 and the transfer roller 17 is short and the adjustable speed range of the registration roller 31 is narrow. This can decrease the distance between toner images formed on the intermediate transfer belt 18. Therefore, the throughput can be enhanced without increasing the size of the apparatus.

Further, when the conveying-speed control for the n-th number recording medium is exerted by using the times taken for the first to n−1-th prints to reach the registration sensor S2, the time T2n taken for the n-th recording medium to move from the paper sensor S1 to the registration sensor S2 can be made closer to T2 as printing proceeds, as shown in FIG. 4.

By exerting the above-described speed control according to the first exemplary embodiment, image formation on various types of recording media can be precisely performed without increasing the size of the apparatus and reducing productivity of the apparatus.

### Second Exemplary Embodiment

The second exemplary embodiment is characterized in an operation performed when a recording-medium sensor detects that a recording medium is not provided in the paper feed tray 13 of the paper feeding device of the first exemplary embodiment.

FIG. 5 is a partial cross-sectional view showing a state in which a recording-medium sensor for detecting the presence or absence of a recording medium is provided in a paper feed tray 13 of a paper feeding device similar to that adopted in the first exemplary embodiment.

The recording-medium sensor includes a lever member 39 that protrudes upward from below an intermediate plate 37 and is pivotally supported by the paper feed tray 13, and a photointerrupter 40 that is disposed in the main body of the paper feeding device and is shielded from light by the lever member 39 when a recording medium is not placed on the intermediate plate 37.

Since the recording-medium sensor is provided, the absence of a recording medium in the paper feed tray 13 is detected even during printing. When recording media are supplied in the paper feed tray 13 and are fed therefrom, detection for the first recording medium is performed. The detection result can be fed back to feeding control of subsequent recording media.

### Third Exemplary Embodiment

The third exemplary embodiment is characterized in an operation performed when a loading sensor detects that a paper feed tray 13 of a paper feeding device is detached.

FIG. 6 schematically shows a structure in which a paper feed tray 13 similar to that in the first exemplary embodiment is detachably loaded in a body of a color-image forming apparatus, and shows a state in which a loading sensor is provided to detect whether the paper feed tray 13 is loaded or unloaded.

In the third exemplary embodiment, the paper feed tray 13 can be drawn out of the body of the apparatus by being pulled rightward in the horizontal direction in FIG. 6, thus allowing recording media to be supplied therein. FIG. 6 shows a state in which the paper feed tray 13 is loaded in the body of the apparatus.

The loading sensor includes a lever member 42 fixed to the paper feed tray 13, and a photointerrupter 43 that is disposed in the paper feeding device and that is shielded from light by the lever member 42 when the paper feed tray 13 is loaded in the color-image forming apparatus.

Since the loading sensor is provided, it is possible to detect even during a job that the paper feed tray 13 is detached and to temporarily stop a paper feeding operation. Even when the paper feed tray 13 is loaded after recording media are supplied therein, when the recording media are fed, a detecting operation for the first recording medium is performed. The result of detection can be fed back to feeding control of subsequent recording media.

The above-described operation and control can also be applied to cases other than the detection of the absence of the recording medium and the detection of detachment of the paper feed tray described in the second and third exemplary embodiments. For example, when printing is stopped during a job because of conveying failure such as a paper jam or a conveyance delay, the above-described detecting operation is carried out again when feeding the first recording medium after stopping, and the result of detection is fed back to feeding control of subsequent recording media. This allows image formation to be precisely achieved even when conveyance failure occurs.

Further, even when the type of stacked recording media changes, a high conveyance performance can be maintained by performing the above-described detection and feedback control.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-336010 filed Dec. 13, 2006, which is hereby incorporated by reference herein in its entirety.

1. An image forming apparatus comprising:
a storage unit configured to store a recording medium;
an image forming unit configured to form an image on the recording medium;
a paper feed unit configured to supply the recording medium from the storage unit;
a conveying unit configured to convey the recording medium supplied by the paper feed unit to the image forming unit; and
a control unit configured to control conveyance of the recording medium by the paper feed unit and the conveying unit,
wherein, in accordance with a conveyance state in which the recording medium supplied from the storage unit by the paper feed unit is conveyed to the conveying unit, the control unit sets a conveying speed of the next recording medium supplied by the paper feed unit.

2. The image forming apparatus according to claim 1, wherein the conveyance state includes a time period between a time when the recording medium is supplied by the paper feed unit and a time when the recording medium reaches the conveying unit.

3. The image forming apparatus according to claim 1, wherein the control unit exerts control so that the first recording medium supplied by the paper feed unit after an input of a print start command is conveyed to the image forming unit after being temporarily stopped at the conveying unit, and so that the second and subsequent recording media supplied by the paper feed unit are conveyed to the image forming unit without being stopped at the conveying unit.

4. The image forming apparatus according to claim 2, wherein the control unit sets a conveying speed of the recording medium supplied by the paper feed unit so that a difference between the time period and a preset period is within a preset range.

5. The image forming apparatus according to claim 2, further comprising:
a first detecting unit configured to detect the recording medium supplied by the paper feed unit,
wherein the conveying speed of the recording medium by the paper feed unit is set on the basis of a time period between a time when the recording medium is supplied by the paper feed unit and a time when the recording medium is detected by the first detecting unit.

6. The image forming apparatus according to claim 5, further comprising:
a second detecting unit configured to detect the recording medium after the recording medium is detected by the first detecting unit and before the recording medium reaches the conveying unit,
wherein the conveying speed of the recording medium by the paper feed unit and the conveying unit is set on the basis of a time period between a time when the recording medium is detected by the first detecting unit and a time when the recording medium is detected by the second detecting unit.

7. The image forming apparatus according to claim 1,
wherein the storage unit includes a presence/absence sensor configured to detect the presence or absence of the recording medium, and
wherein the control unit determines whether to stop the recording medium at the conveying unit in accordance with the detection result of the presence/absence sensor.

8. The image forming apparatus according to claim 1,
wherein the image forming unit includes a bearing member configured to bear a color image, and
wherein the control unit sets the conveying speed of the recording medium by the paper feed unit and the conveying unit so that a leading edge of the color image on the bearing member is synchronized with a leading edge of the recording medium.

9. The image forming apparatus according to claim 1,
wherein the storage unit is detachably loaded in the image forming apparatus,
wherein the image forming apparatus further includes a loading sensor configured to detect loading or unloading of the storage unit, and
wherein the control unit determines whether to stop the recording medium at the conveying unit in accordance with the detection result of the loading sensor.

10. A recording-medium feeding method for an image forming apparatus including a storage unit configured to store a recording medium, an image forming unit configured to form an image on the recording medium, a paper feed unit configured to supply the recording medium from the storage unit, the recording-medium feeding method comprising:
detecting a conveyance state in which the recording medium stored in the storage unit is supplied; and
setting a conveying speed of the next recording medium supplied by the paper feed unit in accordance with the conveyance state.

11. The recording-medium feeding method according to claim 10,
said image forming apparatus further comprising a conveying unit configured to convey the recording medium supplied by the paper feed unit to the image forming unit,
wherein the conveyance state includes a time period between a time when the recording medium is supplied by the paper feed unit and a time when the recording medium reaches the conveying unit, and
wherein a conveying speed of the recording medium by the paper feed unit and the conveying unit is set so that a difference between the time period and a preset period is within a preset range.

12. The recording-medium feeding method according to claim 10, further comprising:
setting the conveying speed of the recording medium by the paper feed unit on the basis of a time period between a time when the recording medium is supplied by the paper feed unit and a time when the recording medium is detected by a first detecting unit.
